(19) United States
(12) Patent Application Publication
(10) Pub. No.: US 2003/0048769 A1
(43) Pub. Date: Mar. 13, 2003

(54) Road-vehicle communication system

(75) Inventor: Hiroshi Yamashita, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/237,114

(22) Filed: Sep. 9, 2002

(30) Foreign Application Priority Data
Sep. 10, 2001 (JP) 2001-273906

(51) Int. Cl. H04B 7/212

(52) U.S. Cl. 370/347

(57) ABSTRACT

A road-side apparatus for transmitting a carrier of a specified frequency has a service presenting state data generating unit and an FCMC generating unit. The service presenting state data generating unit generates data on a service presenting state having a corresponding relationship between information indicating the type of services presented by the road-side apparatus and information indicating that the road radio apparatus uses the carrier of which frequency, every road-side apparatus. The FCMC generating unit multiplexes the data on the service presenting state generated by the service presenting state data generating unit, to transmission data. In an on-vehicle apparatus, a service presenting state data separating unit obtains the data on the service presenting state from the transmission data, and a carrier specifying unit specifies the carrier for presenting a desired service and sets a reception frequency of a receiving unit.

### BACKGROUND OF THE INVENTION

The present invention relates to a communication apparatus on a DSRC (Dedicated Short Range Communication) system, which is used for intelligent transport systems.

In intelligent transport systems (ITSs), radio communication is performed based on a dedicated short range communication (hereinafter, referred to as a DSRC) system between a road-side radio apparatus (hereinafter, referred to as a road-side apparatus) and an on-vehicle radio apparatus (hereinafter, referred to as an on-vehicle apparatus).

FIG. 1 is a frequency arrangement diagram showing frequencies of carriers used by the road-side apparatus and the on-vehicle apparatus in the radio communication on the DSRC system. Referring to FIG. 1, a frequency ranging 5770 MHz to 5850 MHz is used. The road-side apparatus transmits a low frequency 2 to the on-vehicle apparatus.

The on-vehicle apparatus transmits a high frequency 4 to the road-side apparatus. Seven types of carriers are transmitted to the on-vehicle apparatus from the road-side apparatus. Frequencies f1 to f7 of the seven types of carriers are varied depending on the road-side apparatuses. Seven types of carriers are transmitted to the road-side apparatus from the on-vehicle apparatus. Frequencies f1′ to f7′ of the seven types of carriers are varied depending on the on-vehicle apparatuses. The difference between a frequency fn (n=1 to 7) on the low-frequency 2 and a frequency fn′ of the high-frequency 4 is 40 MHz.

A non-stop automatic toll collection (electronic toll collection system, so-called ETC) uses the carriers of the frequencies f1, f2, f1′, and f2′ among the above-mentioned frequencies. For example, the carriers of the remaining frequencies are used for presentation of services such as automatic settlement for auto park management and service stations. The on-vehicle apparatus itself searches for the frequency and catches the carrier which presents desired services, and receives service data from the road-side apparatus.

FIG. 2 is a diagram of the structure showing a transmission system of a conventional road-side apparatus on the DSRC system.

Referring to FIG. 2, a transmission system 106 in the conventional road-side apparatus comprises a transmission data generating unit 8, a modulating unit 10, and a transmitting unit 12. The transmission data generating unit 8 comprises an FCMC (Frame Control Message Channel) generating unit 14, an MDC (Message Data Channel) 16, and a switching unit 18.

The FCMC generating unit 14 generates control data for line control of the radio communication with the on-vehicle apparatus. The MDC generating unit 16 generates the service data on the services presented to the on-vehicle apparatus and BST (Beacon Service Table) data indicating the type of services presented by the road-side apparatus.

The switching unit 18 switches the control data generated by the FCMC generating unit 14, the service data generated by the MDC generating unit 16, and data on the type of services, and then supplies transmission data to the modulating unit 10. The modulating unit 10 modulates the carriers by the transmission data from the switching unit 18. The transmitting unit 12 transmits the carriers transmitted from the modulating unit 10 after modulation by using sufficient power.

Among a plurality of road-side apparatuses, in the road-side apparatus using the carriers of the frequencies f1 and f2, the MDC generating unit 16 generates the service data for ETC. These road-side apparatuses present the services for the ETC.

Next, a description is given of how the on-vehicle apparatus receives the service data from the above-structured road-side apparatus. FIG. 3 is a flowchart showing the operation of the on-vehicle apparatus.

Herein, in two road-side apparatuses using the carriers of the frequencies f4 and f5, a common radio communication zone for general roads is formed to present the services. The road-side apparatus using the carrier of the frequency f5 presents on-vehicle apparatus's desired service.

Hereinbelow, the operation of the on-vehicle apparatus will be described with reference to FIG. 1. A power source is turned on (step S11) and then the on-vehicle apparatus first sets a reception frequency to the frequency f1 (step S12).

In this case, since the road-side apparatus using the carrier of the frequency f1 is not set, synchronous operation is not established (NO in step S13). Then, the on-vehicle apparatus sequentially switches the reception frequency to the subsequent frequencies f2 and f3 (step S12). When the reception frequency is set to the frequency f4, the on-vehicle apparatus receives the carrier from the road-side apparatus using the carrier of the frequency f4. Therefore, the on-vehicle apparatus can establish the synchronous operation (YES in step S13) and a radio link is connected between the road-side apparatuses.

The on-vehicle apparatus demodulates the transmission data from the received carriers, and obtains BST data generated by the MDC generating unit 16 on the road-side apparatus (step S14). The on-vehicle apparatus checks the BST data and determines whether or not the road-side apparatus presents the on-vehicle apparatus's desired service (step S15). Since the desired service is presented by the carrier of the frequency f5, the determination result is NO (NO in step S15).

Thus, the on-vehicle apparatus switches the reception frequency in step S12 to the frequency f5 so as to establish the synchronous operation, similarly to the case of the frequency f4. Thereafter, the on-vehicle apparatus obtains the BST data (steps S12, S13, and S14), and determines whether or not the on-vehicle apparatus's desired service is presented (step S15).

Now, the determination result in step S15 is YES and therefore the on-vehicle apparatus continues the radio communication by the reception frequency f5, extracts the service data from the BST data, performs necessary processing, and receives the desired service (step S16). After that, the on-vehicle apparatus ends the processing on the services presented by the road-side apparatus (step S17) and returns to the processing routine in step S12.

The radio communication zone covered by the road-side apparatus on the DSRC system is narrow. The on-vehicle apparatus on a running vehicle cannot predict when it enters the radio communication zone of the road-side apparatus. Consequently, the on-vehicle apparatus always searches the frequency by switching the reception frequency and establishing the synchronous operation.

In the above-mentioned conventional road-vehicle communication system, the on-vehicle apparatus cannot recognize when and by which carrier the desired service is presented. Hence, the on-vehicle apparatus needs to search the frequency for the carriers which presents the services, of all the possible frequencies f1 to f7.

In some presented services, it is necessary to complete data communication in a short time including a frequency search time of the carrier, within the exceedingly narrow communication zone (within a range of approximately 3 m in the advance direction) such as an ETC tollgate.

When the on-vehicle apparatus enters the radio communication zone of the tollgate while a vehicle thereof receives the carrier of the frequency f3, it must wait for one round of the search and for the frequency return from f7 to f1 so as to catch the frequencies f1 and f2 by the frequency search.

Therefore, the on-vehicle apparatus cannot sufficiently ensure the communication time and toll operation using the ETC might not normally be performed. In the case of adding a new carrier to the seven carriers assigned to the DSRC system, the round time of the frequency search further becomes longer. Furthermore, there is a danger of the deterioration in services requiring high speed for the ETC, etc.

### SUMMARY OF THE INVENTION

Accordingly, it is an object of the present invention to provide a road-vehicle communication system on which on-vehicle apparatus's required time for frequency search is reduced and an on-vehicle apparatus catches a target carrier for service needing high speed and accurately performs the communication without trouble.

In order to accomplish the above-mentioned object, a road-vehicle communication system comprises a plurality of road-side radio apparatuses for communication based on a DSRC system and at least one on-vehicle radio apparatus.

The road-side radio apparatus comprises modulating means for modulating a carrier by transmission data and transmitting means for transmitting the carrier after modulation by the modulating means by sufficient power.

The on-vehicle radio apparatus comprises receiving means for receiving the carrier transmitted by the transmitting means in each of the road-side radio apparatuses by switching a receiving frequency. On the road-vehicle communication system, the frequency of the carrier varies depending on the road-side radio apparatus.

At least one road-side radio apparatus comprises service presenting state data generating means which generates data on a service presenting state having a corresponding relationship between information indicating the type of services presented by the road-side radio apparatus and information indicating that the road-side radio apparatus uses the carrier of which frequency, every road-side radio apparatus, and data multiplexing means which multiplexes the data on the service presenting state which is generated by the service presenting state data generating means, to the transmission data.

On the road-vehicle communication system of the present invention, in at least one road-vehicle radio apparatus, the service presenting state data generating means generates the data on the service presenting state having the corresponding relationship between the information indicating the type of services presented by the road-side radio apparatus and the information indicating that the road-side radio apparatus uses the carrier of which frequency, every road-side radio apparatus. The data multiplexing means multiplexes the data on the service presenting state which is generated by the service presenting state data generating means, to the transmission data.

Therefore, by receiving the transmission data and obtaining data on the service presenting state from at least one road-side radio apparatus to receive the desired service, it can be recognized the carrier of which frequency is to be received. Therefore, in the case of receiving the desired service, the on-vehicle radio apparatus does not need to sequentially switch the reception frequency as in the conventional manner and to check to see if the desired service is presented. The carrier for presenting the desired service is specified from the data on the service presenting state, the reception frequency is promptly set to the frequency of the specified carrier, and the service can be received.

As a result, on-vehicle radio apparatus's required time for frequency search is reduced and the on-vehicle radio apparatus catches a target carrier for service needing high speed and accurately performs the communication without trouble.

### BRIEF DESCRIPTION OF THE DRAWINGS

FIG. 1 is a frequency arrangement diagram showing frequencies of carriers used by the road-side apparatus and the on-vehicle apparatus on the DSRC system radio communication;

FIG. 2 is a diagram of the structure showing a transmission system of a conventional road-side apparatus on the DSRC system;

FIG. 3 is a flowchart showing the operation of the on-vehicle apparatus;

FIG. 4A is a block diagram showing one example of a transmission system of the road-side apparatus forming a road-vehicle communication system of the present invention;

FIG. 4B is a block diagram showing one example of a reception system of the on-vehicle apparatus forming the road-vehicle communication system of the present invention; and

FIG. 5 is a flowchart showing the operation in the reception system in FIG. 4B.

### DESCRIPTION OF THE PREFERRED EMBODIMENTS

Next, an embodiment of the present invention will be described with reference to the drawings.

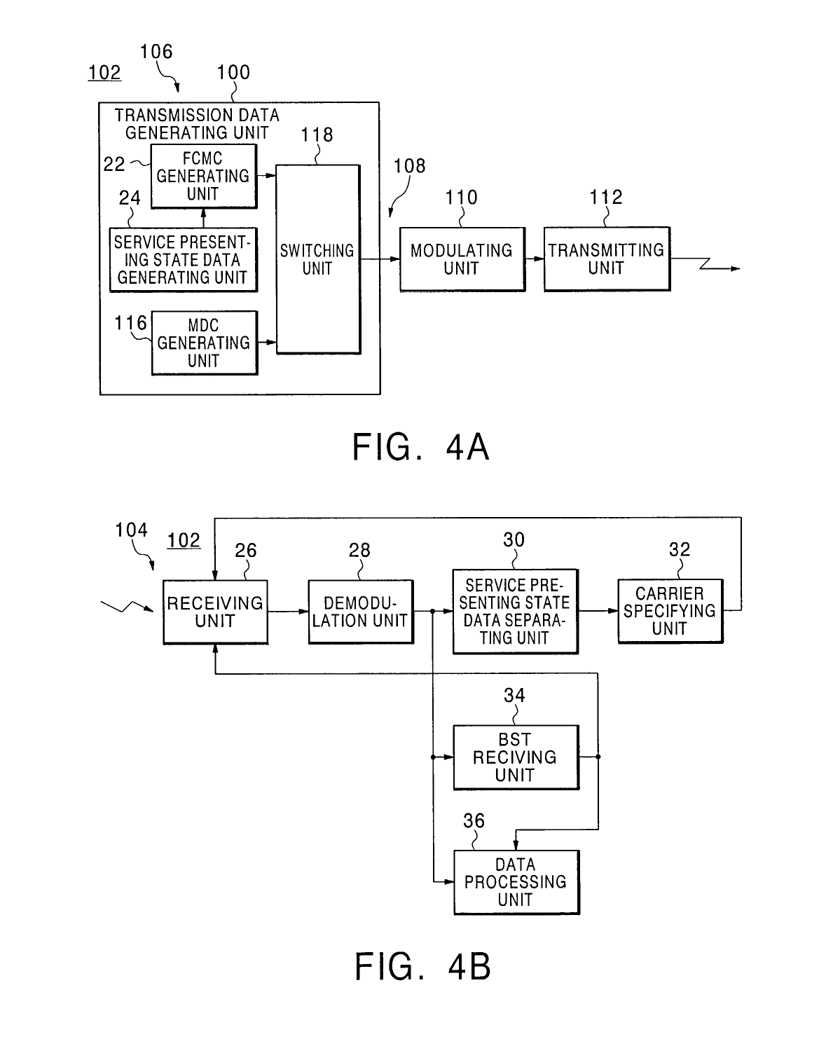

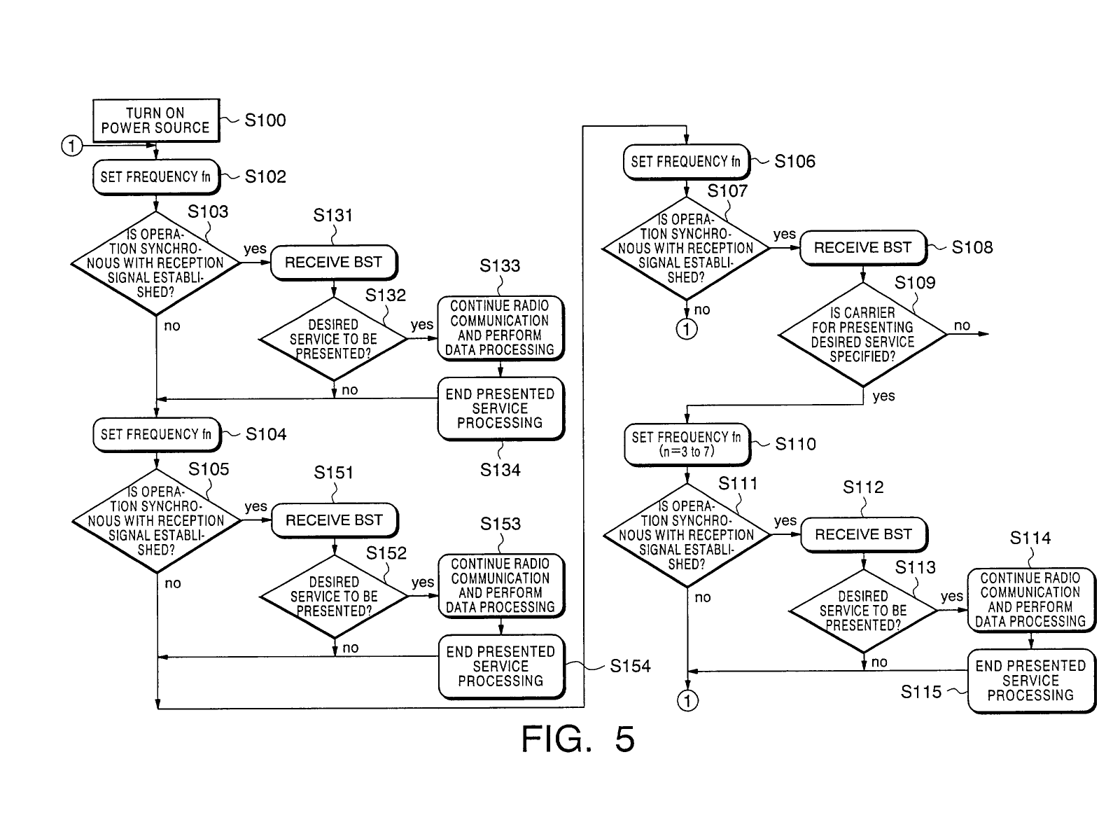

FIG. 4A is a block diagram showing one example of a transmission system of a road-side apparatus forming a road-vehicle communication system of the present invention. FIG. 4B is a block diagram showing one example of a reception system of the on-vehicle apparatus forming the road-vehicle communication system of the present invention. FIG. 5 is a flowchart showing the operation in the reception system in FIG. 4B.

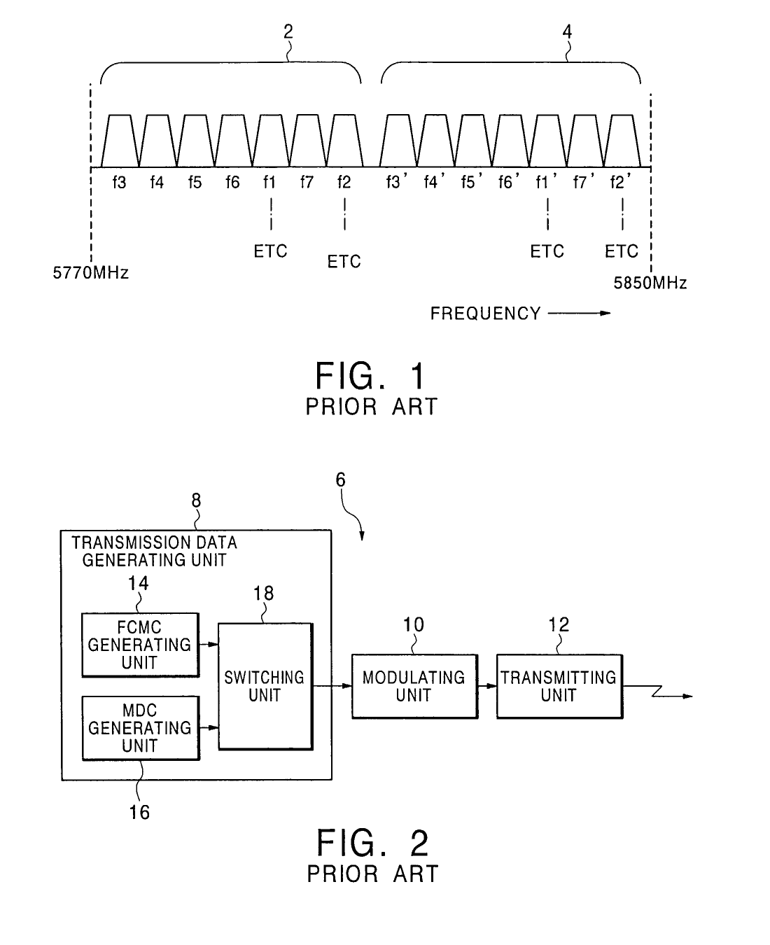

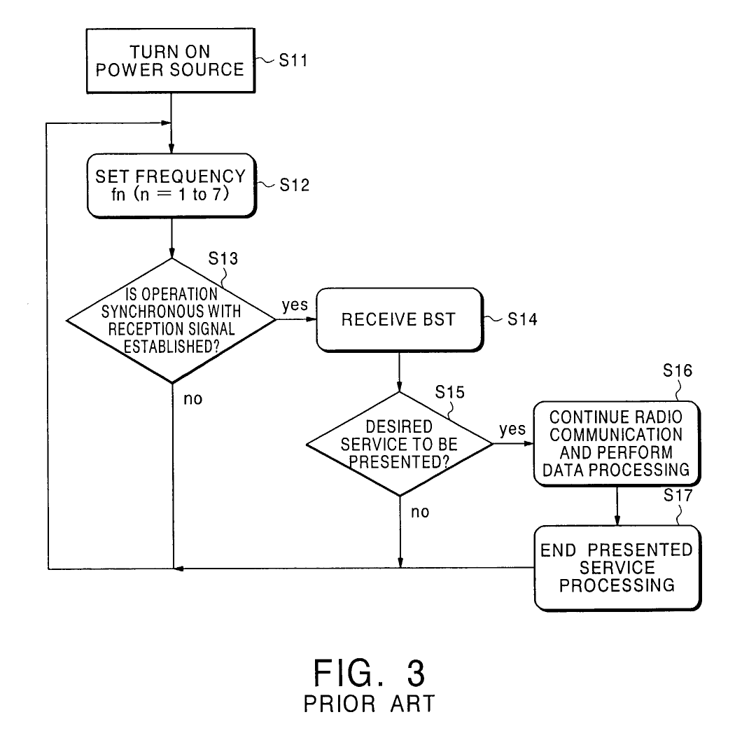

Referring to FIGS. 4A and 4B, the same components as those in FIG. 2 are designated by the same reference numerals. An actual road-side apparatus has a reception system and an actual on-vehicle apparatus has a transmission system. However, these reception system and transmission system do not have a direct relationship to the present invention and a description is omitted.

A road communication system 102 according to an embodiment comprises a plurality of road-side apparatuses for communication based on the DSRC system and at least one on-vehicle apparatus 104. Among the plurality of road-side apparatuses, the road-side apparatus using the carriers of the frequencies f1 and f2 (refer to FIG. 1) comprises an MDC generating unit 116 which will be described later, for generating service data for ETC. The road-side apparatus presents the service on the ETC. The road-side apparatus using the carrier of the frequency f3, as a master road-side apparatus 106, presents data on the service presenting state to the on-vehicle apparatus 104.

Except for the road-side apparatus for transmitting the carrier of the frequency f3 (master road-side apparatus 106), the transmission system of the road-side apparatus forming the road-vehicle communication system 102 according to the present embodiment has the same structure as that of the conventional transmission system shown in FIG. 2. Therefore, only the transmission system of the master road-side apparatus will be described.

Referring to FIG. 4A, a transmission system 108 of the master road-side apparatus 106 comprises a transmission data generating unit 100, a modulating unit 110, and a transmitting unit 112. The transmission data generating unit 100 comprises an FCMC generating unit 22 (data multiplying means of the present invention), a service presenting state data generating unit 24, an MDC generating unit 116 (service data generating means of the present invention), and a switching unit 118.

The service presenting state data generating unit 24 generates data on the service presenting state having a corresponding relationship between information indicating the road-side apparatus uses the carrier of which frequency and information indicating the type of services presented by the road-side apparatus, every road-side apparatus.

Similarly to the conventional unit, the FCMC generating unit 22 generates control data for line control of the radio communication with the on-vehicle apparatus 104, and multiplexes the data on the service presenting state generated by the service presenting state data generating unit 24 to the control data.

In the master road-side apparatus 106, the control data obtained by multiplexing the data on the service presenting state, as the transmission data, is supplied to the modulating unit 110 via the switching unit 118. The carrier of the frequency f3 is modulated by the transmission data and is transmitted by the transmitting unit 112.

Referring to FIG. 4B, the reception system of the on-vehicle apparatus 104 forming the road-vehicle communication system 102 comprises a receiving unit 26, a demodulating unit 28, a service presenting state data separating unit 30, a carrier specifying unit 32, a BST receiving unit 34, and a data processing unit 36.

The receiving unit 26 receives the carrier, which is obtained by switching the reception frequency and is transmitted by the transmitting unit 112 of each road-side apparatus. The demodulating unit 28 establishes the synchronous operation of the carrier received by the receiving unit 26, and demodulates the transmission data based on the carrier. The service presenting state data separating unit 30 separates the data on the service presenting state, which is multiplexed to the transmission data from the transmission data demodulated by the demodulating unit 28.

The carrier specifying unit 32 specified the carrier used by the road-side apparatus which presents the service desired by the on-vehicle apparatus 104, based on the data on the service presenting state separated by the service presenting state data separating unit 30. The receiving unit 26 is controlled by the carrier specifying unit 32 so that the frequency of the specified carrier becomes the reception frequency.

The BST receiving unit 34 extracts the BST data (data on the type of services of the present invention) from the transmission data demodulated by the demodulating unit 28. The BST receiving unit 34 checks the extracted BST data, and determines whether or not the road-side apparatus presents the desired service. The data processing unit 36 extracts the service data from the transmission data demodulated by the demodulating unit 28, and executes processing on the service presented by the road-side apparatus based on the service data.

Next, a description is given of how the on-vehicle apparatus 104 receives the service data from the road-side apparatus 106 on the above-structured road-vehicle communication system 102.

Herein, two road-side apparatuses (106) using the carriers of the frequencies f4 and f5 form a common radio communication zone for general roads and presents the service. The on-vehicle apparatus 106 using the carrier of the frequency f5 presents the desired service of the on-vehicle apparatus 104.

Hereinbelow, the operation of the on-vehicle apparatus 104 will be described with reference to FIG. 5. When starting a vehicle engine having the on-vehicle apparatus 104, the power source of the on-vehicle apparatus 104 is turned on (step S100). The receiving unit 26 in the on-vehicle apparatus 104 first sets the reception frequency to the frequency f1 (step S102). In this case, the road-side apparatus using the carrier of the frequency f1 for ETC is set only to an express way. As mentioned above, since the demodulating unit 28 is not set to the general roads, the carrier of the frequency f1 is not transmitted and the synchronous operation is not established (NO in step S103). Thus, the receiving unit 26 next switches the reception frequency to the frequency f2 (step S104). However, the frequency f2 only for ETC is not transmitted and the demodulating unit 28 does not establish the synchronous operation (NO in step S105).

Next, the reception unit 26 in the on-vehicle apparatus 104 sets the reception frequency to the frequency f3 (step S106). The master road-side apparatus 106 transmits the carrier of the frequency f3. Therefore, the receiving unit 26 receives the carrier and the demodulating unit 28 establishes the synchronous operation (YES in step S107), and demodulates the transmission data from the master road-side apparatus 106 (step S108). The service presenting state data separating unit 30 separates the data on the service presenting state which is multiplexed to the transmission data, from the transmission data demodulated by the demodulating unit 28. The carrier specifying unit 32 specifies the carrier used by the road-side apparatus, which presents the desired service, based on the data on the service presenting state. As a result, when the carrier corresponding to the desired service is specified (YES in step S109), the reception frequency is set to the frequency of the specified carrier under the control of the receiving unit 26 (step S110). According to the present embodiment, since the desired service is presented by the road-side apparatus using the carrier of the frequency f5, the carrier specifying unit 32 sets the frequency f5 as the reception frequency to the receiving unit 26.

Thus, the receiving unit 26 sets the frequency f5 as the reception frequency and receives the carrier thereof. The demodulating unit 28 establishes the synchronous operation and demodulates the transmission data from the carrier (YES in step S111). The BST receiving unit 34 extracts the BST data from the transmission data demodulated by the demodulating unit 28. Further, the BST receiving unit 34 checks the BST data and determines whether or not the road-side apparatus presents the desired service (steps S112 and S113). In this case, the determination result is YES and therefore the BST receiving unit 34 fixes the reception frequency to the frequency f5 and continues the reception of the carrier of the frequency f5. The BST receiving unit 34 starts the data processing unit 36. Thus, the data processing unit 36 extracts the service data from the transmission data demodulated by the demodulating unit 28, executes processing of the service presented by the road-side apparatus, based on the service data (step S114). The data processing unit 26 ends the processing and then the end of the processing is informed to the receiving unit 26 (step S115). Consequently, the receiving unit 26 starts the frequency search again (step S102).

As mentioned above, according to the present embodiment, on the on-vehicle communication system 102, the on-vehicle apparatus 104 receives the transmission data from the master road-side apparatus 106, and obtains the data on the service presenting state data. Thus, it is possible to recognize the carrier of which frequency is to be received so as to receive the desired service. Therefore, when the desired service is received, the on-vehicle apparatus 104 does not need to check whether or not, conventionally, the desired service is presented by sequentially switching the reception frequency. The on-vehicle apparatus 104 specifies the carrier for presenting the desired service, from the data on the service presenting state, and promptly sets the frequency of the specified carrier, thereby receiving the service.

As a result, the on-vehicle apparatus 104 can reduce a required time for the frequency search, can catch the desired carrier which presents the service requiring the high speed, and can accurately perform the communication without trouble.

According to the present embodiment, since the road-side apparatus for ETC is not set, the determination results in steps S103 and 105 are NO. On the other hand, when the road-side apparatus for ETC is set in the toll road such as the express way, the determination results in steps S103 and 105 are YES and the on-vehicle apparatus 104 performs the data processing for ETC.

That is, if the determination result in step S103 is YES, the BST receiving unit 34 in the on-vehicle apparatus 104 extracts the BST data from the transmission data demodulated by the demodulating unit 28 (step S131), and determines whether or not the desired service (service for ETC) is presented by checking the BST data (steps S132). The determination result in steps S132 is YES, and the BST receiving unit 34 allows the receiving unit 26 to fix the reception frequency to the frequency f1, thereby continuing the reception of the carrier of the fixed frequency f1. Then, the BST receiving unit 34 starts the data processing unit 36. Thus, the data processing unit 36 extracts the service data from the transmission data demodulated by the demodulating unit 28, and executes the processing for the service presented by the road-side apparatus, based on the service data (step S133). The data processing unit 36 ends the processing and the end of the processing is informed to the receiving unit 26 (step S134). As a result, the receiving unit 26 sets the reception frequency to the frequency f2. If the service is not one for ETC in step S132, the processing routine advances to step S104.

If the determination result in step S104 is YES, the BST receiving unit 34 in the on-vehicle apparatus 104 extracts the BST data from the transmission data demodulated by the demodulating unit 28 (step S151), checks the BST data, and determines whether or not the road-side apparatus presents the desired service (service for ETC) (step S152).

The determination result in step S152 is YES. Then, the BST receiving unit 34 allows the receiving unit 26 to fix the reception frequency to the frequency f2 so as to continue the reception of the carrier of the fixed frequency f2, and starts the data processing unit 36. Thus, the data processing unit 36 extracts the service data from the transmission data demodulated by the demodulating unit 28, and executes the processing of the service for ETC presented by the road-side apparatus, based on the service data (step S153). The data processing unit 36 ends the processing and the end of processing is informed to the receiving unit 26 (step S154). As a result, the receiving unit 16 next sets the reception frequency to the next frequency f3. If the service is not one for ETC in step S152, the processing routine advances to step S106.

According to the present embodiment, one road-side apparatus, that is, only the master road-side apparatus 106 comprises the service presenting state data generating unit 34 for generating and transmitting the data on the service presenting state.

However, by providing the service presenting state data generating unit 34 for all the road-side apparatuses which transmit the carriers of the frequencies f3 to f7, except for the frequencies f1 and f2 dedicated for ETC, all the road-side apparatuses including the master road-side apparatus 106 can transmit the data on the service presenting state. In the above-mentioned structure, if the carrier of the frequency f3 is not received for some reason, the carrier of the next frequency f4 is received, the data on the service presenting state can be obtained, and the desired service can promptly be received.

As mentioned above, on the road-vehicle communication system of the present invention, at least one road radio apparatus generates the data on the service presenting state having a corresponding relationship between information indicating the type of services presented by the road-side radio apparatus and information indicating the road-side radio apparatus uses the carrier of which frequency, every road-side radio apparatus. The data multiplexing means multiplexes the data on the service presenting state which is generated by the data on the service presenting state, to the transmission data.

Therefore, in the on-vehicle radio apparatus, it is possible to recognize the carrier of which frequency is to be received by receiving the transmission data from at least one road-side radio apparatus and obtaining the data on the service presenting state so that the desired service is presented. Thus, when the desired service is presented, the on-vehicle radio apparatus does not need to check whether or not, conventionally, the desired service is presented by sequentially switching the reception frequency. Further, the carrier for presenting the desired service is specified from the data on the service presenting state and the reception frequency of the specified carrier is promptly set.

As a result, the on-vehicle radio apparatus can reduce a required time for the frequency search, and can catch the desired carrier which presents the service requiring the high speed and can accurately perform the communication without trouble.

What is claimed is:

1. A road-vehicle communication system, comprising a plurality of road-side radio apparatuses and at least one on-vehicle radio apparatus, said road-side radio apparatus for communication based on a DSRC system comprising modulating means for modulating a carrier by transmission data and transmitting means for transmitting the carrier after modulation by said modulating means by sufficient power, said on-vehicle radio apparatus comprising receiving means for receiving the carrier transmitted by said transmitting means in each of said road-side radio apparatuses by switching a reception frequency,
wherein at least said one road-side radio apparatus comprises:
service presenting state data generating means which generates data on a service presenting state having a corresponding relationship between information indicating the type of services presented by said road-side radio apparatus and information indicating that said road-side radio apparatus uses the carrier of which frequency, every road-side radio apparatus; and
data multiplexing means which multiplexes the data on the service presenting state which is generated by said service presenting state data generating means, to the transmission data.

2. A system as claimed in claim 1, wherein:
said road-side radio apparatus further comprises FCMC generating means which generates control data for line control of radio communication with said on-vehicle radio apparatus, as the transmission data, and multiplexes the data on the service presenting state to the control data.

3. A system as claimed in claim 2, wherein:
said road-side radio apparatus further comprises service data generating means which generates service data on services presented to said on-vehicle radio apparatus as the transmission data.

4. A system as claimed in claim 3, wherein:
said road-side radio apparatus further comprises switching means which switches the transmission data generated by said FCMC generating means and the transmission data generated by said service data generating means and supplies the switched data to said modulating means.

5. A system as claimed in claim 3, wherein:
in said two road-side radio apparatuses among said plurality of road-side radio apparatuses, said service data generating means generates the service data for non-stop automatic toll collection as the transmission data.

6. A system as claimed in claim 5, wherein:
all said road-side radio apparatuses excluding one having said service data generating means which generates the service data for the non-stop automatic toll collection, comprise said service presenting state data generating means and said FCMC generating means.

7. A system as claimed in claim 1, wherein said on-vehicle radio apparatus comprises:
demodulating means which demodulates the transmission data from the carrier received by said receiving means;
service presenting state data separating means which separates the data on the service presenting state multiplexed to the transmission data, from the transmission data demodulated by said demodulating means; and
carrier specifying means which specifies the carrier used by said road-side radio apparatus for presenting a desired service, based on the data on the service presenting state separated by said service presenting state data separating means, and controls said receiving means so that the frequency of the specified carrier is set to the reception frequency.

8. A system as claimed in claim 3, wherein:
said service data generating means in each of said road-side radio apparatuses generates the service data and data on the type of services presented by said road-side radio apparatus, as the transmission data.
